(19) United States
(12) Patent Application Publication
(10) Pub. No.: US 2022/0374036 A1
(43) Pub. Date: Nov. 24, 2022

(54) ENERGY-PROFILE COMPENSATION USING FEED-FORWARD WITH A WIRED OR WIRELESS LINK

(71) Applicant: RAYTHEON TECHNOLOGIES CORPORATION, Waltham, MA (US)

(72) Inventors: Kaiyu Wang, Round Rock, TX (US); Vladimir Blasko, Avon, CT (US); William A. Veronesi, Hartford, CT (US); Moon C. Kim, Glastonbury, CT (US); Robert K. Thornton, Coventry, CT (US)

(21) Appl. No.: 17/734,390

(22) Filed: May 2, 2022

Related U.S. Application Data
(63) Continuation of application No. 15/743,140, filed on Jan. 9, 2018, now abandoned.

(51) Int. Cl. G05F 1/66; B66B 1/30; B66B 1/24

(52) U.S. Cl. CPC G05F 1/66; B66B 1/302; B66B 1/24; H02J 3/003

(57) ABSTRACT

An energy storage assembly includes an energy storage unit. A supervisor is operable to determine a power reference set point based upon a cost function. A storage unit controller is configured to control the energy storage unit to provide electric energy to at least one load based upon a power reference input that is based upon the power reference set point and at least one dynamically changing power profile from the at least one load.

### STATEMENT REGARDING FEDERALLY SPONSORED RESEARCH OR DEVELOPMENT

This invention was made with government support under Contract No. DE-EE0003954, awarded by the Department of Energy. The Government has certain rights in this invention.

### BACKGROUND

This disclosure relates to power generation and consumption, and more particularly, but without limitation, to using an energy storage assembly to provide stored electric energy to a load.

There can be a variety of loads served by a power grid and having varying power profiles for different operating conditions. It follows that the power drawn from the utility grid to service such loads can quickly vary dramatically, which is not favored by the utility company. There are challenges associated with minimizing fluctuations in the power drawn from the utility grid for supplying these dynamic loads.

### SUMMARY

An energy storage assembly according to an illustrative embodiment includes an energy storage unit. A supervisor is operable to determine a power reference set point based upon a cost function. A storage unit controller is configured to control the energy storage unit to provide electric energy to at least one load based upon a power reference input that is based upon the power reference set point and at least one dynamically changing power profile from the at least one load.

In an assembly having one or more features of the assembly of the previous paragraph, the load communicates the power profile to the controller wirelessly.

In an assembly having one or more features of an assembly of the previous paragraphs, the power profile indicates variations in power draw by the at least one load, and the variations occur within seconds.

In an assembly having one or more features of an assembly of the previous paragraphs, the load is an elevator.

In an assembly having one or more features of an assembly of the previous paragraphs, the supervisor determines the power reference set point based on minimizing fluctuations in power drawn from a supply grid.

In an assembly having one or more features of an assembly of the previous paragraphs, there are a plurality of loads, there are a plurality of dynamically changing power profiles, and the supervisor determines the power reference set point based on the average power offset by the dynamic load.

In an assembly having one or more features of an assembly of the previous paragraphs, the load is one of a plurality of loads and the power reference input is based on a dynamically changing power profile from each of the plurality of loads.

In an assembly having one or more features of an assembly of the previous paragraphs, the dynamically changing plurality of loads communicate the power profiles wirelessly to the controller.

In an assembly having one or more features of an assembly of the previous paragraphs, the plurality of loads are elevators.

In an assembly having one or more features of an assembly of the previous paragraphs, the energy storage unit is a battery.

An illustrative example method of servicing a load includes determining a power reference set point based on a cost function, determining a dynamically changing power profile of the load, providing the power reference set point and the dynamically changing power profile to an energy storage unit, and providing electrical energy from the energy storage unit to the load based upon the input.

In a method having one or more features of the method of the previous paragraph, the power profile varies among operations of the load.

In a method having one or more features of a method of the previous paragraphs, determining the power reference set point is based on minimizing fluctuations in power drawn from a supply grid.

In a method having one or more features of a method of the previous paragraphs, the inputting the power profile includes wireless communication to the energy storage unit.

In a method having one or more features of a method of the previous paragraphs, wherein the load is an elevator.

In a method having one or more features of a method of the previous paragraphs, the method includes determining a second dynamically changing power profile of a second load.

In a method having one or more features of a method of the previous paragraphs, the method includes inputting the second dynamically changing power profile to the energy storage unit.

In a method having one or more features of a method of the previous paragraphs, the method includes providing electrical energy from the energy storage unit to the second load based upon the input.

### BRIEF DESCRIPTION OF THE DRAWINGS

FIG. 1 schematically illustrates a power supply system.

FIG. 2 schematically illustrates an example elevator assembly.

FIG. 3 illustrates a load profile of the example elevator assembly.

FIG. 4 schematically illustrates the power information flow for the example energy storage assembly.

FIG. 5 graphically illustrates the grid current utilized by a system without the example energy storage assembly.

FIG. 6 graphically illustrates the grid current utilized by a system with the example energy storage assembly.

FIG. 7A graphically illustrates profiles of load power and energy storage power when utilizing the example energy storage assembly.

FIG. 7B graphically illustrates the profile of grid power when utilizing the example energy storage assembly.

### DETAILED DESCRIPTION

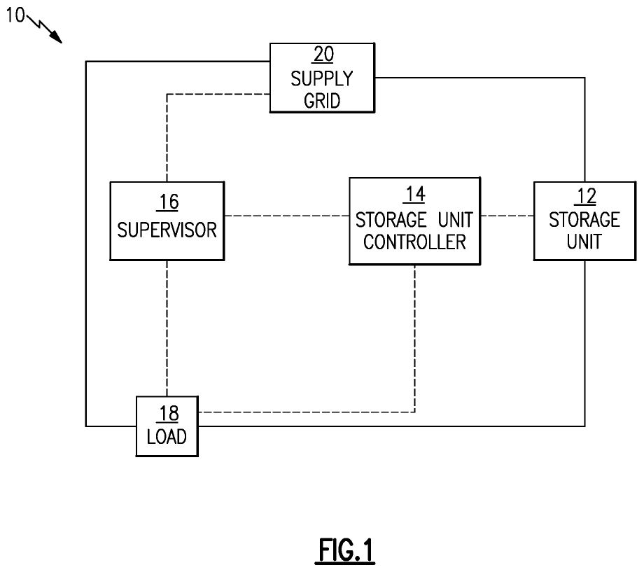

FIG. 1 schematically illustrates an example power supply system 10, including an energy storage assembly that provides electric power to a building, a campus, or a location, for example. The power supply system 10 includes an energy storage unit 12 that has an associated storage unit controller 14. In one example, the energy storage unit 12 comprises a battery that can receive power to increase a charge of the battery and provide power to other portions of the system 10. A supervisor 16 is in communication with the storage unit controller 14, a load 18, and a supply grid 20. The example supply grid 20 is a utility power grid. The load 18 is connected to normally receive electric power from the supply grid 20.

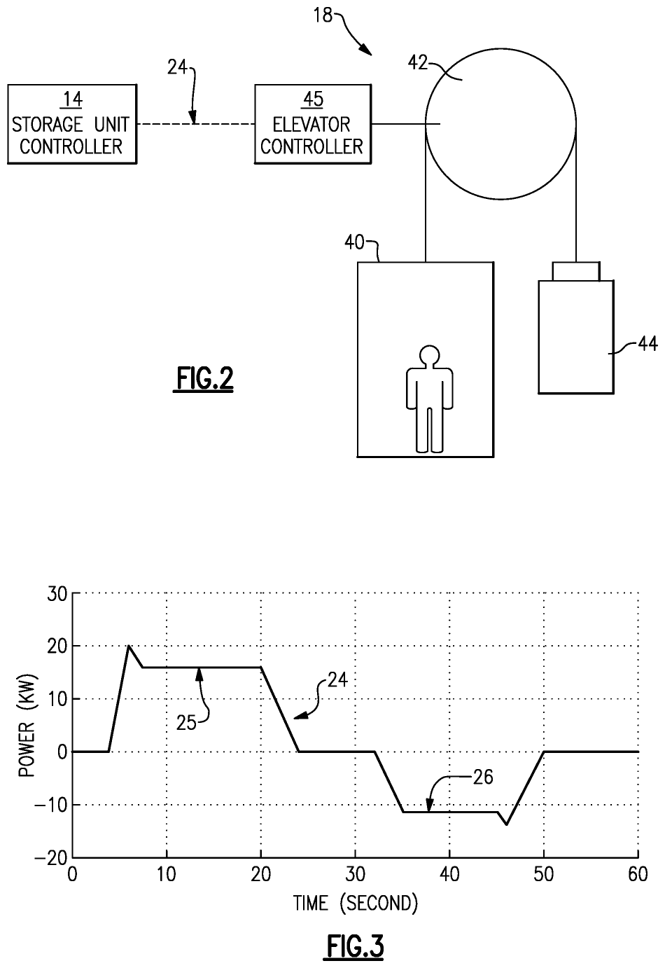

In one example, as shown in FIG. 2, the load 18 serviced by the power supply system 10 comprises an elevator system. The power consumption of elevators can vary rapidly and greatly, and elevators equipped with regenerative drives may even inject power into the grid, depending on operating conditions. One elevator system 18 consists of a car 40, a machine 42, and a counterweight 44 that operate in a known manner. The elevator system 18 further includes an elevator controller 45 in communication with the energy storage unit controller 14. The elevator controller 45 communicates a power profile 24 of the elevator to the energy storage unit controller 14. The power profile indicates changes associated with power consumption by the elevator system 18. The power profile indicates dynamic changes in power that may occur on a relatively short-term basis.

Although many electric loads in building systems draw almost constant power for their operation, the load 18 is considered a dynamic load. The power required to operate a dynamic load can vary dramatically among separate operations. The elevator system 18 is an example dynamic load. The power absorbed or produced by the elevator depends on the weight of a car 40 for the operation, which varies among operations. Under some conditions, the machine 42 may operate as a generator of electricity. In some systems, the electricity generated by the machine is wasted, while in other systems the excess power may be pushed back into the grid.

FIG. 3 is representative of a power profile 24 of the elevator system 18. When the power reading is greater than zero as shown at 25, the elevator absorbs power from the supply grid 20. When the power reading is less than zero as shown at 26, power may be supplied into the grid. If the power servicing the elevator system 18 were only drawn from the supply grid 20, heavy fluctuations in the power draw would result. The illustrated dynamic changes or fluctuations occur within a matter of seconds (less than a minute in the example). Such dramatic variations in the power drawn from the supply grid 20 are not favored by utility companies. The example power supply assembly 10 utilizes feed forward information from the load 18 to rapidly address such conditions for using the energy storage unit 12 to at least augment power to service the elevator system 18 to compensate for the variations in power required by the dynamic load, minimizing the fluctuations in power drawn from the supply grid 20.

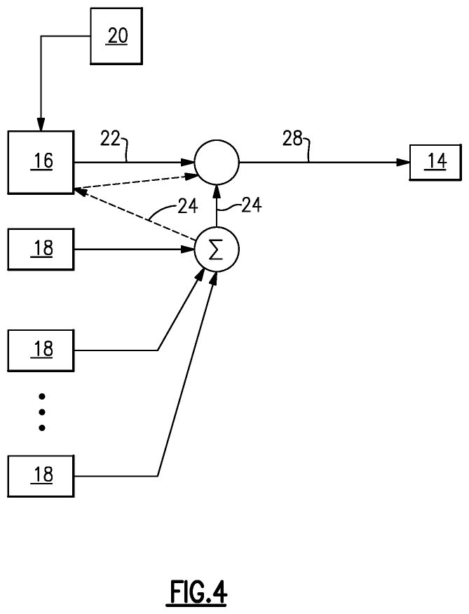

FIG. 4 schematically shows the power flow control for the example power supply assembly 10. The supervisor 16 determines a power reference set point 22 based upon a cost function. For example, the cost function may include a threshold value of power drawn from the grid because utility companies often issue contracts with progressively large rates for power drawn greater than some threshold value. The cost function may also be designed not to allow regenerative power to flow back to the grid. The example supervisor 16 is in communication with the supply grid 20, and the power reference set point 22 is based on minimizing fluctuations in the power drawn from the supply grid 20. The supervisor 16 may also take into account the average power offset of the load 18 in determining the power reference set point 22. The load 18 communicates a dynamically changing power profile 24 indicative of the electrical power required to operate the load 18 to the storage unit controller 14. When the load 18 is an elevator system, the elevator controller 45 communicates the power profile 24 to the storage unit controller 14.

The load supervisor 16 and the storage unit controller 14 may be separate, combined, or partially combined, such that the load 18 may communicate the power profile 24 to the storage unit controller 14 and/or the supervisor 16. In other words, the supervisor 16 and the controller 14 are schematically illustrated for discussion purposes. Those skilled in the art who have the benefit of this description will realize that combination of hardware, software or firmware will best suit their particular needs.

The load 18 may be a single load or it may be a plurality of loads. That is, the dynamically changing power profile 24 used by the controller 14 and/or the supervisor 16 may be indicative of the power profile of a single load or the summation of the power profiles of a plurality of loads, as shown in FIG. 4. The power profile 24 is the sum of the feed forward requirements of the load or loads 18. The storage unit controller 14 receives the power profile 24 information and the power reference set point 22 as a power reference input signal 28, which may be determined by the supervisor 16. The storage unit controller 14 then determines, based upon the power reference input signal 28, the amount of energy the storage unit 12 should supply to the load 18. The storage unit 12 provides electrical energy to the load 18 in response to a command from the storage unit controller 14.

In one application, the load power profile 24 is sent wirelessly through a wireless link between the load 18 and the storage unit controller 14. In the elevator system 18, for example, the power profile 24 is sent wirelessly from the elevator controller 45 to the storage unit controller 14. Various known wireless communication protocols may be used, such as Wi-Fi, Bluetooth, or ZigBee.

Communication among 14, 16, 18, and 20 can be achieved via either wired or wireless means. Wireless communication has several advantages over its wired alternatives. First, devices that provide the profile information can be dynamically plug-and-playable with minimal cost. Wireless communication does not require routing wires among the communicating components, minimizing material costs, installation costs, and commissioning time. Second, wireless communication provides flexibility of location of the devices involved and distances between hosts due to its minimal deployment cost. Wireless communication allows almost any topology of host configuration for various types of microgrid systems. Further, a change in physical location will incur little or no additional cost for communication system reconfiguration.

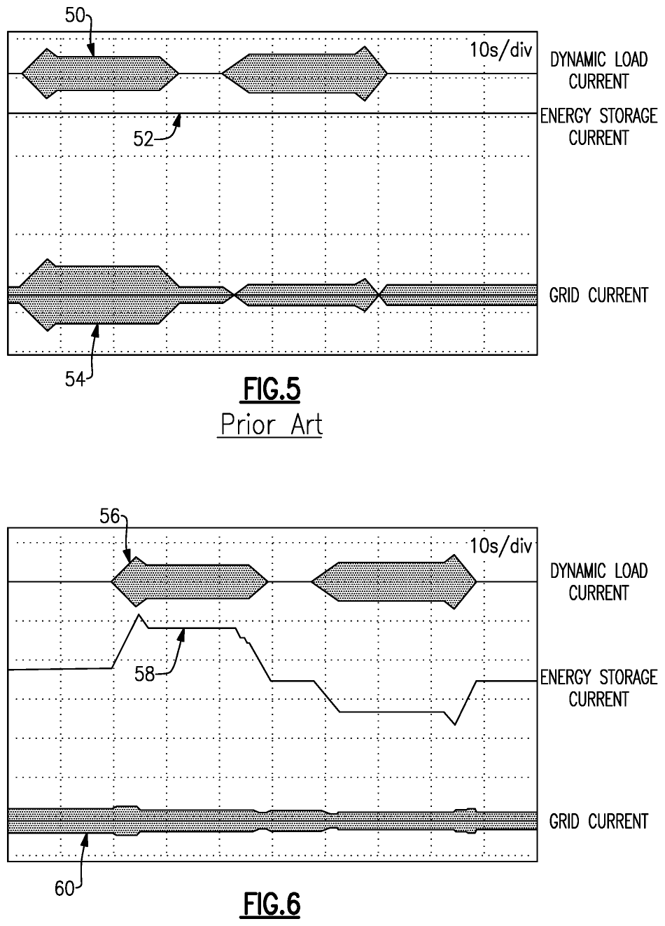

FIG. 5 shows power characteristics of a system that does not utilize the example energy storage unit 12. Plot 50 represents changes in the current utilized by the elevator system 18, plot 52 represents changes in the current provided to the load by energy storage unit 12 (which corresponds to no change because the storage unit 12 is not used to address the changes shown at 50), and plot 54 represents the changes in current drawn from supply grid 20 to service the elevator system 18. As shown, with variations of the current (plot 50) utilized by elevator system 18, there are also large fluctuations in the necessary current (plot 54) drawn from supply grid 20 in order to meet the needs of the elevator system 18. That is, because the elevator system 18 draws from the supply grid 20 without any supply from the storage unit 12, a noticeable or significant fluctuation in the required power for operating the elevator system 18 occurs. In FIG. 5, the fluctuations occur in just over one minute.

FIG. 6 shows power characteristics of a system that does utilize the example energy storage unit 12. Plot 56 represents changes in the current utilized by the elevator system 18, plot 58 represents the current provided to the load by energy storage unit 12, and plot 60 represents changes in the current drawn from supply grid 20 to service the elevator system 18. After receiving the power reference set point 22 from the supervisor 16 and the power profile 24 from the elevator controller 45, the storage unit controller 14 commands the energy storage unit 12 to provide electric current (plot 58) to the elevator system 18. The current drawn from the supply grid 20 (plot 60) remains relatively constant, while the energy storage unit 12 provides most of the necessary changes in energy supplied to the elevator system 18 for operation. Thus, the power supply system 10 services the rapidly varying electrical power needs of the elevator system 18 without causing large fluctuations in the power supplied by the supply grid 20. As can be appreciated by comparing the plots 54 (FIG. 5) and 60 (FIG. 6), the grid current is much more stable or constant with the disclosed feed forward compensation provided by the storage unit 12 and the controller 14.

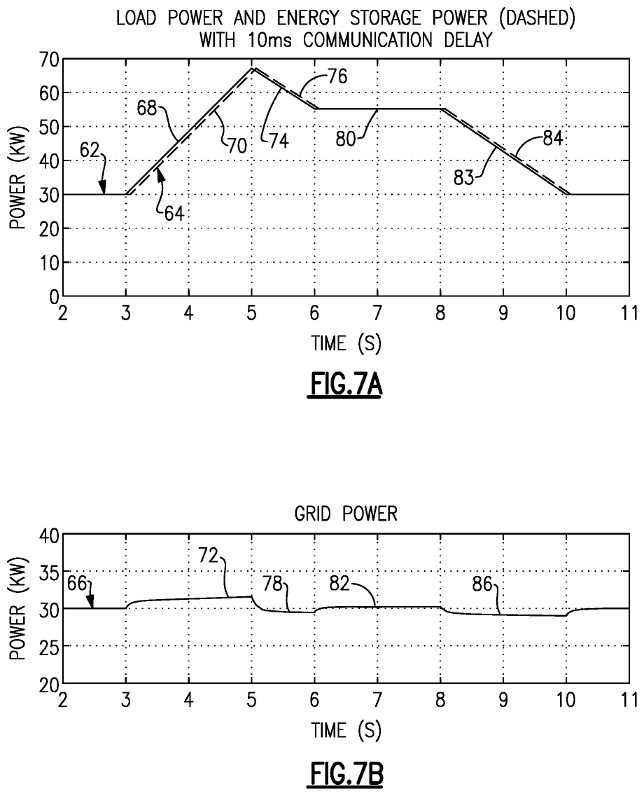

FIG. 7A illustrates in more detail how the power supply from the storage unit 12 tracks the changes in power demand of the elevator system 18. The plot 62 represents the required load power of elevator system 18. The plot 64 (dashed line) shows power supplied by the energy storage unit 12 to service the elevator system 18 over the same time period. FIG. 7B shows a plot 66 of the amount of power drawn from the supply grid 20 during the same time period. An increase 68 in the required elevator system power is compensated for by an increase 70 in the power supplied by the storage unit 12 to the elevator system 18. There is roughly a 10 ms communication delay between the elevator system 18 power and the storage unit 12 power. The delay is based on the required communications between the supervisor 16, the elevator controller 45, and the storage unit controller 14.

The supplemental power from energy storage unit 12 tracks the change in the elevator system 18 power demand dynamically. The corresponding resulting increase 72 in the power supplied by the supply grid 20 is thus minimal. As the elevator system power decreases at 74, the storage unit 12 power provided also decreases at 76, resulting in minimal fluctuation at 78 in power drawn from the supply grid 20. As the elevator system power and storage unit 12 provided power flatten out at 80, the supply grid 20 power flattens out at 82 as well. Then, as the elevator system 18 power decreases at 83, the storage unit 12 provided power decreases at 84 at roughly the same rate and amount with a slight communication delay. It follows that the resulting decrease at 86 in the power supplied by the supply grid 20 is minimal. Thus, the example power supply system 10 services the elevator system 18 having power fluctuations in excess of 36 kW within a matter of seconds, but the resulting fluctuations in the supply grid 20 power are only +/−2 kW.

Although different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments. Although a particular component arrangement is disclosed and illustrated in these exemplary embodiments, other arrangements could also benefit from the teachings of this disclosure.

The preceding description is exemplary rather than limiting in nature. Variations and modifications to the disclosed examples may become apparent to those skilled in the art that do not necessarily depart from the essence of this disclosure. Thus, the scope of legal protection can only be determined by studying the following claims.

We claim:

1. An energy supply assembly comprising:
an energy storage unit;
a supervisor operable to determine a power reference set point based upon a cost function and based on minimizing fluctuations in power drawn from a supply grid;
a storage unit controller configured to control said energy storage unit to provide electric energy to an elevator based upon a power reference input that is based upon said power reference set point and at least one dynamically changing power profile from said elevator.

2. The energy storage assembly as recited in claim 1, wherein said elevator communicates said power profile to said storage unit controller wirelessly.

3. The energy storage assembly as recited in claim 1, wherein said power profile indicates variations in power draw by said elevator, the variations occurring within seconds.

4. The energy storage assembly as recited in claim 1, wherein said supervisor determines said power reference set point based on minimizing fluctuations in power drawn from a supply grid.

5. The energy assembly as recited in claim 4, wherein
there are a plurality of loads;
there are a plurality of dynamically changing power profiles; and
said supervisor determines said power reference set point based on the average power offset by the loads.

6. The energy storage assembly as recited in claim 1, wherein said elevator is one of a plurality of loads, and said power reference input is based on a dynamically changing power profile from each of said plurality of loads.

7. The energy storage assembly as recited in claim 6, wherein said plurality of loads communicate said dynamically changing power profiles wirelessly to said storage unit controller.

8. The energy storage assembly as recited in claim 7, wherein said plurality of loads are elevators.

9. The energy storage assembly as recited in claim 1, wherein said energy storage unit is a battery.

10. A method of servicing a load, comprising:
determining a power reference set point;
determining a dynamically changing power profile of an elevator based upon a cost function and based on minimizing fluctuations in power drawn from a supply grid;
inputting said power reference set point and said dynamically changing power profile to an energy storage unit; and
providing electrical energy from said energy storage unit to said elevator based upon said input.

11. The method as recited in claim 10, wherein said inputting said power profile includes wireless communication to said energy storage unit.

12. The method as recited in claim 10, wherein said power profile varies among operations of said load.

13. The method as recited in claim 10, wherein determining said power reference set point is based on minimizing fluctuations in power drawn from a supply grid.

14. The method as recited in claim 10, comprising
determining a second dynamically changing power profile of a second load;
inputting said second dynamically changing power profile to said energy storage unit; and
providing electrical energy from said energy storage unit to said second load based upon said second power profile input.
